(19) United States
(12) Patent Application Publication
(10) Pub. No.: US 2015/0139627 A1
(43) Pub. Date: May 21, 2015

(54) MOTION PICTURE PLAYBACK APPARATUS AND METHOD FOR PLAYING BACK MOTION PICTURE

(71) Applicant: Panasonic Intellectual Property Management Co., Ltd., Osaka (JP)

(72) Inventors: Naoya KAWASHITA, Osaka (JP); Hidemi OKA, Hyogo (JP); Hiroyuki MIYAHARA, Kanagawa (JP)

(21) Appl. No.: 14/534,228

(22) Filed: Nov. 6, 2014

(30) Foreign Application Priority Data
Nov. 19, 2013 (JP) 2013-238477
Oct. 27, 2014 (JP) 2014-217961

(51) Int. Cl. H04N 5/783; G11B 27/00

(52) U.S. Cl. CPC H04N 5/783; G11B 27/005
USPC 386/344

(57) ABSTRACT

A motion picture playback apparatus that achieves a more effective playback in slow motion is disclosed. The motion picture playback apparatus includes a read-out section for reading out a motion picture stream from a recording medium that records the motion picture stream containing a motion picture stretch formed of a group of frames shot at 1/N times speed, and a processing section for providing the group of frames with a frame interpolation process in the case of playing back the read-out motion picture stream, and playing back the group of frames at a speed slower than the 1/N times speed when the motion picture stretch in the motion picture stream is played back.

### TECHNICAL FIELD

The present disclosure relates to a motion picture playback apparatus and a method for playing back a motion picture.

### BACKGROUND

Patent literature 1 discloses a motion picture playback apparatus that shoots a moving subject at a high speed for allowing the shot subject to be played back in slow-motion.

Patent Literature: Unexamined Japanese Patent Application Publication No. 2008-072682

### SUMMARY

The present disclosure aims to provide a motion picture playback apparatus and a method for playing back a motion picture in slow-motion more effectively.

To achieve the foregoing objective, the motion picture playback apparatus disclosed in the present disclosure comprises a readout section and a processing section. The readout section reads a motion picture stream from a storage medium that records the motion picture stream containing a motion picture stretch formed of a group of frames shot at 1/N times speed. When the motion picture stream read-out is played back, the processing section provides the motion picture stretch, formed of the group of frames shot at 1/N times speed, with a frame-interpolation process, and then plays back a stream of the motion picture stretch at a lower speed than the 1/N times speed.

The play-back method disclosed in this disclosure comprises the steps of:
reading a motion picture stream from a storage medium that records the motion picture stream containing a motion picture stretch, formed of a group of frames shot at 1/N times speed and
providing the motion picture stretch of the motion picture stream with a frame-interpolation process, and then playing back a stream of the motion picture stretch at a lower speed than the 1/N times speed.

The present disclosure allows providing the motion picture playback apparatus and the method for playing back the motion picture that achieve a more effective playback in slow motion.

### BRIEF DESCRIPTION OF DRAWINGS

FIG. 1 is a block diagram illustrating an electrical structure of a digital video camera in accordance with an embodiment of the present disclosure.

FIG. 2 is a flowchart of recording a motion picture that includes a slow stretch shot with the digital video camera in accordance with the embodiment.

FIG. 3 is a flowchart of playing back the motion picture that includes the slow stretch shot with the digital video camera in accordance with the embodiment.

FIG. 4 schematically illustrates relations among an output from a CMOS image sensor, a record stream, and played back data.

### DETAILED DESCRIPTION OF PREFERRED EMBODIMENTS

An exemplary embodiment of the present disclosure will be detailed below with reference to the accompanying drawings. An excessive description is omitted. For instance, a description of a well-known subject in a public domain is omitted, or a description of a similar element to that discussed previously is omitted for avoiding redundancy and facilitating an ordinary skilled person in the art to understand the present disclosure.

The inventors provide the accompanying drawings and the description for the ordinary skilled person in the art to fully understand the disclosure, so that these materials may not limit the scope of the claims.

A number of methods for measuring an object distance, a distance from an imaging apparatus to an object includes a depth from Defocus (DFD) method that utilizes correlation values of defocusing amounts generated in image captured with a camera. In general, a defocusing amount is uniquely determined for each imaging apparatus in response to a relation between a focal position and the object distance. In the DFD method utilizing the above characteristics, two images having different defocus amounts are produced, and the object distance is measured based on a point-spread function (PSF) and a difference in the defocusing amounts. The imaging apparatus in accordance with this embodiment measures the object distance by utilizing the DFD calculation to perform an auto-focus control.

A structure and operation of the imaging apparatus in accordance with the embodiment will be described below.

### 1. Electrical Structure of Imaging Apparatus

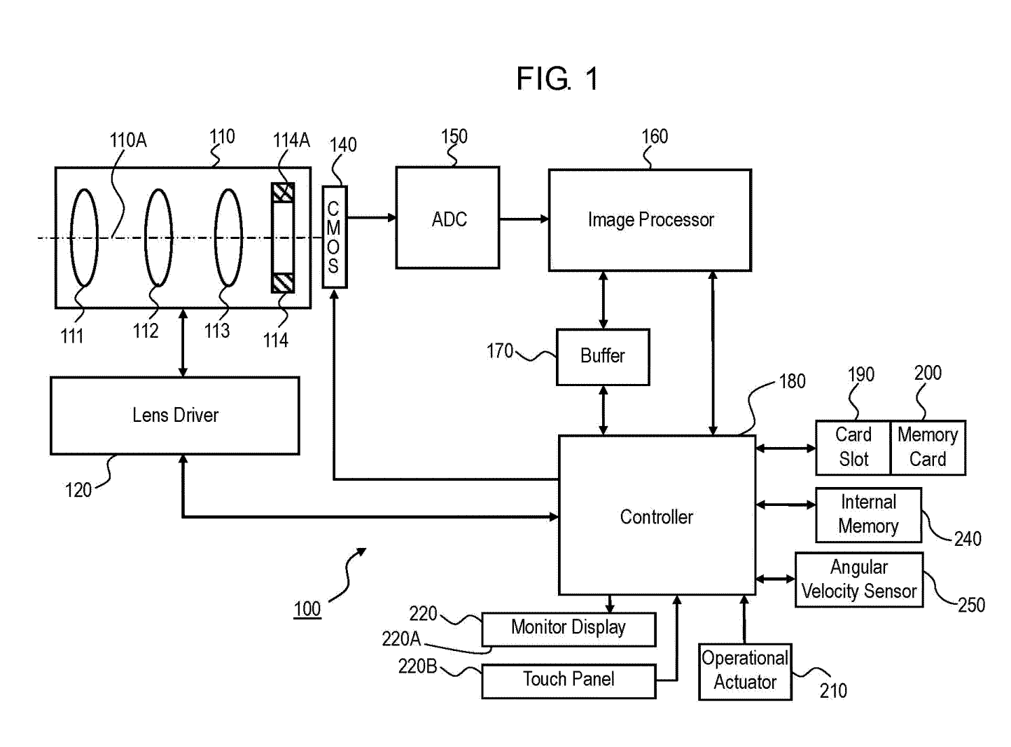

FIG. 1 is a block diagram of digital video camera 100, an imaging apparatus in accordance with the embodiment, for illustrating an electrical structure of digital video camera 100. Digital video camera 100 includes optical system 110 including at least one lens. Optical system 110 forms an object image on CMOS image sensor 140 by utilizing light from an object. The object image is captured with an image sensor, CMOS image sensor 140. CMOS image sensor 140 produces image data based on the captured object image. The image data produced by CMOS image sensor 140 is converted into a digital signal with A/D converter (ADC) 150, and processed with image processor 160. The digital signal is stored in memory card 200. The structure of digital video camera 100 will be detailed below.

Optical system 110 in accordance with the embodiment includes zoom lens 111, camera-shake correcting lens 112, focus lens 113, and iris 114. Zoom lens 111 moves along optical axis 110X to enlarge and reduce the object image. Focus lens 113 moves along optical axis 110X to adjust a focus of the object image. Camera-shake correcting lens 112 is movable within a plane perpendicular to optical axis 110X of optical system 110. Camera-shake correcting lens 112 moves along a direction in which a shake of digital video camera 100 is cancelled as to reduce an influence caused by the shake of camera 100 on the captured image. Iris 114 has opening 114A therein disposed on optical axis 110X, and adjusts the size of opening 114A automatically or according to a user's setting, so that iris 114 can adjust an amount of light transmitting through iris 114.

Lens driver 120 includes a zoom actuator that drives zoom lens 111, a camera-shake correcting actuator that drives camera-shake correcting lens 112, a focus actuator that drives focus lens 113, and an iris actuator that drives iris 114. Lens driver 120 controls the zoom actuator, the camera-shake correcting actuator, the focus actuator, and the iris actuator.

CMOS image sensor 140 captures the object image formed by optical system 110, and produces analog image data in form of an analog signal. CMOS image sensor 140 performs various operations, such as exposure, transfer, and electronic shutter. CMOS image sensor 140 is able to output motion image data at a rate of 120 frames per second (120 fps).

A/D converter 150 converts the analog image data produced by CMOS image sensor 140 into digital image data in form of a digital signal.

Image processor 160 processes the image data produced by CMOS image sensor 140 to produce image data to be displayed on monitor display 220 and to produce image data to be stored in memory card 200. For instance, image processor 160 performs a gamma correction, a white-balance correction, and a flaw correction on the image data produced by CMOS image sensor 140. Image processor 160 compresses the image data produced by CMOS image sensor 140 by a compression method in accordance with H.264 standard or MPEG2 standard. Image processor 160 may be implemented by a DSP or a microprocessor.

Image processor 160 switches the image processing, given to shot image data supplied at the rate of 120 fps from CMOS image sensor 140, depending on a shooting at a normal speed and a shooting at a high speed. During the normal speed shooting, image processor 160 provides one thin-out process every two sequential frames in the shot image data supplied at the rate of 120 fps from CMOS image sensor 140, thereby generating shot image data having a rate of 60 fps. This is hereinafter referred to as frame thin-out mode. Controller 180 stores the generated motion image data having the rate of 60 fps in memory card 200. On the other hand, during the high speed shooting, image processor 160 does not give the thin-out process to the shot image data supplied at the rate of 120 fps from CMOS image sensor 140, and generates motion image data to be played back at a rate of 60 fps. This is hereinafter referred to as frame non thin-out mode. Controller 180 then stores the generated motion image data in memory card 200. Since this method records the entire frames, without thin-out process, of the shot image data supplied at 120 fps from CMOS image sensor 140, and then generates the motion image data, so that the motion image data at a ½ times speed can be obtained.

In this embodiment, the shot image data is supplied at a rate of 120 fps from CMOS image sensor 140; however, the rate is not limited to this one. For instance, the rate can be 180 fps or 240 fps as long as it is a multiple of 60 fps. In this case, the entire frames are recorded without the thin-out process, and then the motion image data to be played back at 60 fps is generated, the motion image data becomes a motion picture stream to be played back at 1/N times speed of a normal shooting speed such as ⅓ times speed or ¼ times speed.

Controller 180 controls entire digital video camera 100, and can be implemented by a semiconductor element. Controller 180 can be implemented by hardware, or by a combination of hardware and software. Controlled may be implemented by a microprocessor.

Buffer 170 functions as a working memory of image processor 160 and controller 180, and can be implemented by, e.g. a DRAM or a ferroelectric memory.

Card slot 190 holds memory card 200 detachably, and is mechanically or electrically connectable to memory card 200. Memory card 200 contains a flash memory or a ferroelectric memory therein, and stores data, such as an image file produced in image processor 160.

Internal memory 240 is implemented by a flash memory or a ferroelectric memory, and stores a control program that controls entire digital video camera 100.

Operational member 210 includes user interfaces, such as a cross key, an enter-button, for accepting operations by users. Operational member 210 includes a motion picture recording button for giving a command to start/stop recording a motion picture, a local slow button for giving a command to record a part of a motion picture at slow speed during a recording of the motion picture at a normal speed, and a motion picture play-back button for giving a command to start/stop playing back a motion picture. These buttons are used for both starting and stopping the foregoing functions respectively. However, these buttons are not necessarily limited to the combined use. For instance, individual buttons for starting and stopping the function can be prepared. The motion picture recording button, the local slow button, and the motion picture play-back button can be disposed as hard-keys on an outer jacket of digital video camera 100, or these buttons can be soft-keys such as button icons displayed on screen 220A of monitor display 220 and operated via touch panel 220B.

Monitor display 220 has screen 220A that displays thereon an image indicated by the image data produced by CMOS image sensor 140 and an image indicated by the image data read out from memory card 200. Monitor display 220 plays back motion image data of 60 fps recorded in memory card 200 at the rate of 60 frames per second. In other words, during the shooting at normal speed, the shot image data supplied from CMOS image sensor 140 at 120 fps and provided with thin-out process becomes motion image data of 60 fps, which is now played back at a normal speed. On the other hand, during the shooting at high speed, the shot image data supplied from CMOS image sensor 140 at 120 fps and provided with no thin-out process becomes motion image data, which is now played back at ½ times speed.

Monitor display 220 displays various menus for setting functions of digital video camera 100 on screen 220A. Touch panel 220B is disposed on screen 220A. Touch panel 220B is touched by a user for receiving various touch actions. An instruction entering through touch panel 220B as a touch action is supplied to controller 180 to be processed.

Angular velocity sensor 250 detects an angular velocity produced in digital video camera 100 due to a camera shake. The angular velocity detected by sensor 250 is supplied to controller 180. Controller 180 drives camera-shake correcting lens 112 to cancel a camera shake produced in digital video camera 100 due to the angular velocity.

### 2. Action of Digital Video Camera

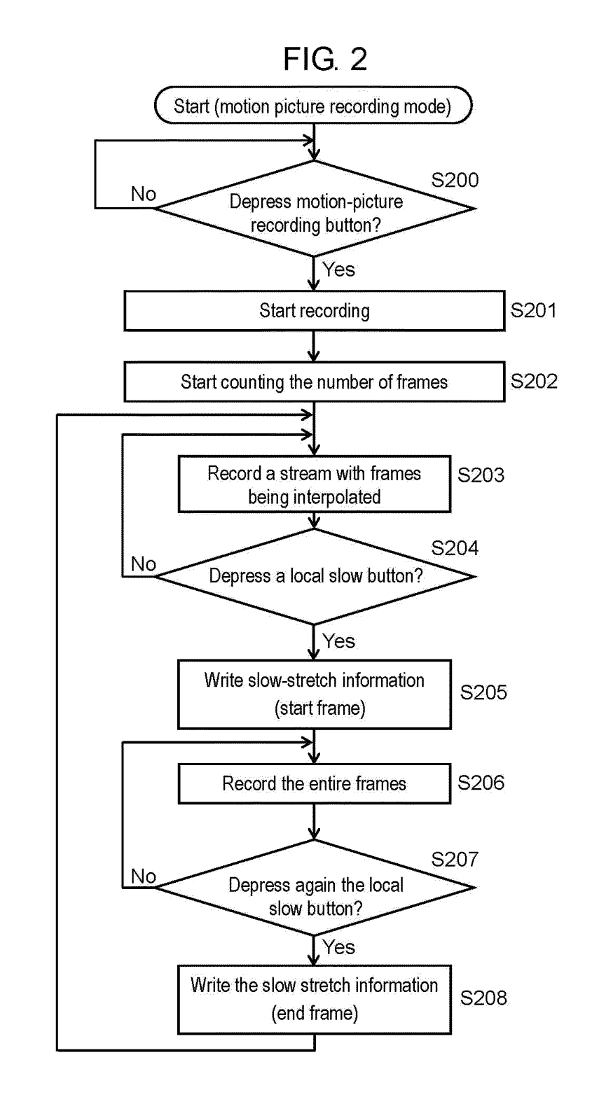

Actions of digital video camera 100 in recording and playing back a motion picture are demonstrated hereinafter with reference to FIGS. 2-4. Digital video camera 100 works as a motion picture recording apparatus and also as a motion picture playback apparatus.

### 2-1. Motion Picture Recording Action

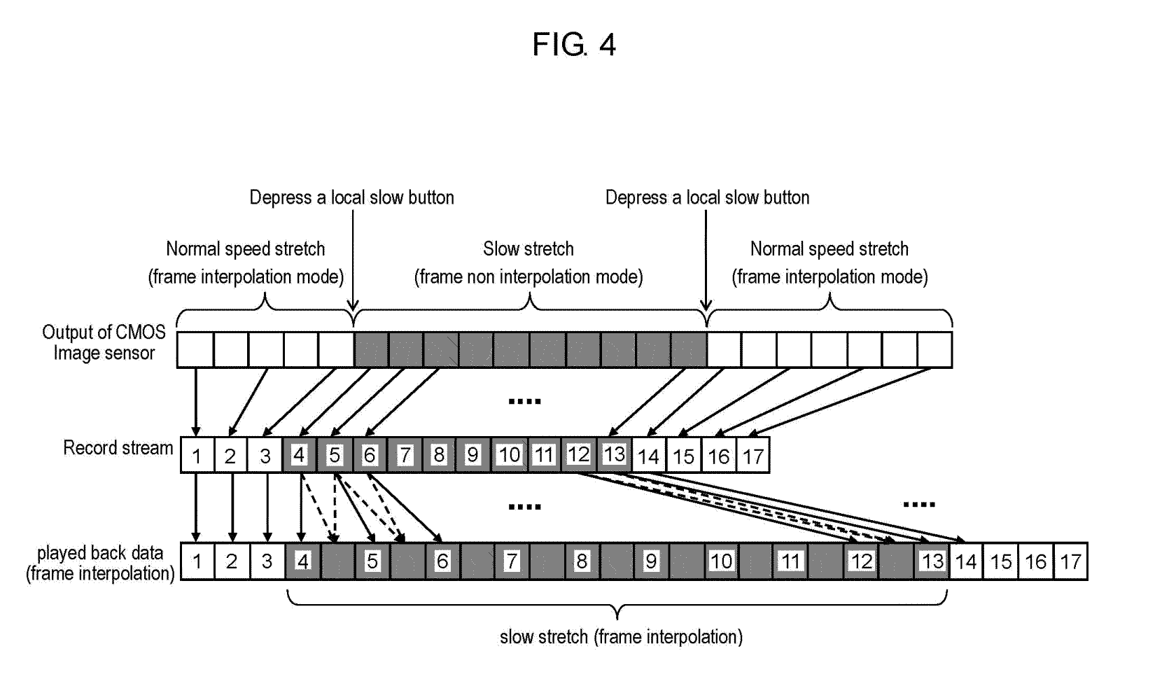

The action of recording a motion picture is demonstrated with reference with FIG. 2 and FIG. 4. FIG. 2 is a flowchart of recording a motion picture shot with digital video camera 100. This flowchart includes a slow stretch. FIG. 4 schematically illustrates relations among an output from CMOS image sensor 140, a record stream, and played back data.

The power supply of digital video camera 100 is turned on, then controller 180 feeds necessary electric power to each of structural elements of camera 100. Receiving the electric power, each of the structural elements such as lenses of optical system 110 and CMOS image sensor 140 complete initial settings to be ready for action.

Digital video camera 100 includes a motion picture recording mode for recording a motion picture and a motion picture playback mode for playing back a motion picture. Turning on the power supply of digital video camera 100 into the recording mode prompts CMOS image sensor 140 to start shooting a subject image. Monitor display 220 then displays a through-image based on shot image data generated by CMOS image sensor 140. Watching the through-image displayed on monitor display 220, a user determines an angle of view and so on before depressing the motion picture recording button of the operational member 210 at an appropriate timing for starting the record of the motion picture.

As FIG. 2 shows, controller 180 monitors whether or not the motion picture recording button is depressed (step S200). Until the depression of the recording button, controller 180 stays in step S200. Upon the depression of the recording button (branch Yes of step S200), controller 180 prompts image processor 160 to start recording motion image data based on the image shot by CMOS image sensor into memory card 200 (step S201). The motion image data can be temporarily stored in buffer 170 before the data is written into memory card 200. In this case, when the motion image data stored in buffer 170 exceeds a given amount, the exceeding amount can be written into memory card 200 by controller 180.

Receiving the command from step S201 to start recording, controller 180 starts counting the number of frames of the motion image data to be recorded (step S202). At this time, as the record stream shown in FIG. 4 illustrates, controller 180 numbers a frame recorded in the first place as the first frame, and then controller 180 numbers the frames sequentially. For instance, frame number 816 is the frame counted by controller 180 as the 816th frame. Until the user depresses the local slow button, image processor 160 provides a thin-out process (frame thin-out mode) to the shot image data supplied at the rate of 120 fps from CMOS sensor 140 as shown in FIG. 4, and generates motion image data of 60 fps, namely, the number of frames per unit time is reduced to a half. Image processor 160 then keeps recording the motion image data into memory card 200 (step S203).

The thin-out process in this embodiment is this: As FIG. 4 shows, CMOS image sensor 140 outputs the shot image data at the rate of 120 fps, and the thin-out process allows recording frames every other frame in the record stream. A process of reducing the frame rate can be done this way: Two sequential frames are combined into one frame, which is then recorded, thereby reducing the number of frames per unit time to a half.

During the record of the motion image data, controller 180 monitors whether or not the local slow button is depressed (step S204). Upon the depression of the local slow button of operational member 210 (branch Yes of step S204), controller 180 writes slow-stretch information (i.e. a serial number of a start frame of the slow-stretch. In the case of example of FIG. 4, the start frame is the fourth frame.) into control information that controls the motion image data under recording (step S205). This control information is needed when the recorded motion image data is played back, and contains information of recording date and time, information of recording mode, information of slow stretch, thumb-nail image, and so on. The control information is recorded in memory card 200 together with the motion image data. The control information can be temporarily recorded in buffer 170 as the motion image data is done before the control information is recorded in memory card 200. In this case, controller 180 writes the information of the slow stream into the control information recorded in buffer 170. Controller 180 can write the control information recorded in buffer 170 into memory card 200 periodically.

The process proceeds to step S206, where controller 180 changes the frame thin-out mode to the frame non thin-out mode, in which all the frames of shot image data supplied at the rate of 120 fps from CMOS image sensor 140 are recorded. Until the local slow button is depressed, controller 180 keeps recording in the frame non thin-out mode as FIG. 4 shows.

In the frame non thin-out mode, since a high speed shooting is carried out, controller 180 handles audio data silently and records it into memory card 200. Because the motion image data is recorded in such an amount of data as the number of frames compatible with the high speed shooting as discussed above; however, the audio data is not recorded in an amount compatible with the high speed shooting. The audio data thus cannot be played back compatible with the play-back of the motion image data. If the audio data is handled audibly and recorded, the data amount of the audio data does not correspond to the motion image data shot at the high speed. As a result, the playback of the audio data together with the motion image data sounds uncomfortable to listeners.

During the high speed shooting, controller 180 monitors whether or not the local slow button is depressed (step S207). In the case of depressing the local slow button (branch Yes of step S207), controller 180 writes a serial number of a frame corresponding to a timing of depressing the local slow button into the control information (step S208). This serial number is handled as slow stretch information (i.e. an end frame of the slow stretch, in the example shown in FIG. 4, the thirteenth frame).

Then the process returns to step S203, where controller 180 changes the frame non thin-out mode to the frame thin-out mode, and then keeps recording in the frame thin-out mode until the local slow button of operational member 210 is depressed next time.

A record-stop action is done by depressing the motion picture recording button. The record-stop action is an interrupt action, and it is executed at an appropriate timing during the record of the motion picture after the depression of the motion picture recording button. Controller 180 stops recording of the motion image data into memory card 200 upon the depression of the motion picture recording button.

During the high speed shooting in the frame non thin-out mode (step S206), a depression of the motion picture recording button of operational member 210 prompts controller 180 to write a serial number of a frame corresponding to the timing of the depression of the motion picture recording button as slow stretch information into the control information. This is a similar action to when the local slow button is depressed in step S207 discussed above. Then controller 180 stops recording the motion image data into memory card 200.

### 2-2. Motion Picture Playback Action

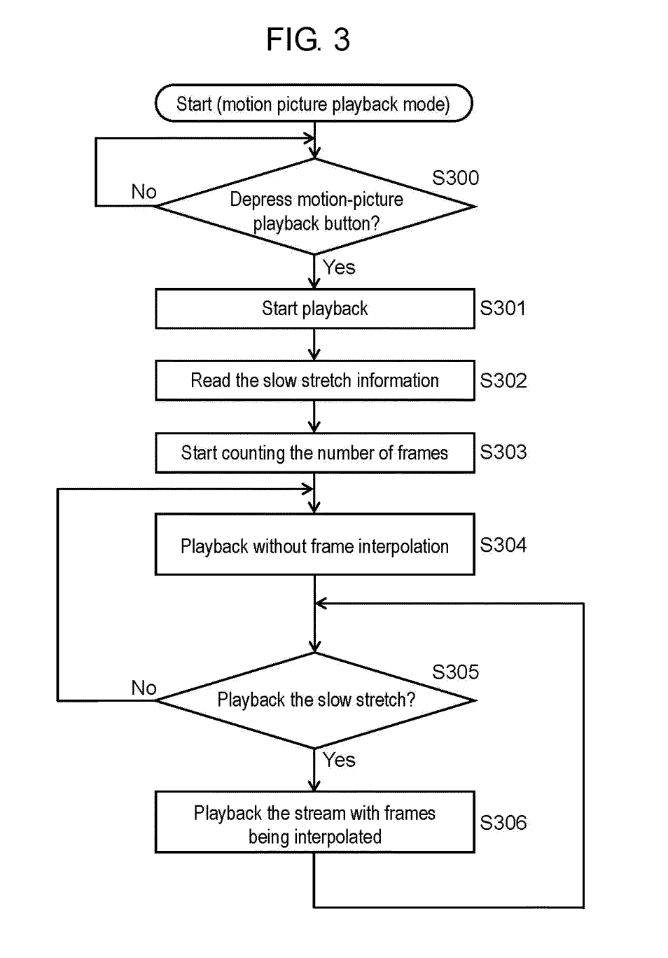

A motion picture playback action by digital video camera 100 is demonstrated hereinafter with reference to FIG. 3 and FIG. 4. FIG. 3 is a flowchart of playing back the motion picture that includes the slow stretch shot with digital video camera 100. When digital video camera 100 is set in the picture playback mode, controller 180 reads the thumbnail images from the control information recorded in memory card 200, and monitor display 220 displays a list of thumbnail images read out. The user selects any one of the thumbnail images from the list, thereby determining the motion image data to be played back.

Controller 180 monitors whether or not the motion picture playback button is depressed (step S300). A depress of the motion picture playback button (branch Yes of step S300) prompts controller 180 to read out a motion picture stream of the motion image data to be played back from memory card 200, and then image processor 160 starts the playback process (step S301). Controller 180 serves the function of the readout section that reads out the motion picture stream to be played back from memory card 200. A selection of the motion image data to be played back can be a trigger for starting the playback process instead of the depression of the motion picture playback button.

Next, controller 180 reads in the slow stretch information from the control information that controls the motion image data to be played back. The slow stretch information includes the information of a start frame and an end frame (step S302). Controller 180 thus understands in which frame-stretch a high speed shooting was carried out when the motion image data to be played back has been recorded. In other words, controller 180 obtains the serial numbers of the start frame and the end frame of the slow stretch shot at a high speed and recorded.

Upon receiving the command to start the playback, controller 180 starts counting the number of frames of the motion image data to be played back (step S303). At this time, controller 180 numbers the frame to be played back firstly as the first frame as illustrated by the played back data in FIG. 4, and then numbers sequentially the frames in the order of playback. For instance, frame number 816 is the frame counted by controller 180 as the 816th frame.

In the case of playing back the motion image data not in the slow stretch, controller 180 prompts image processor 160 to play back the motion image data (first to third frames shown in FIG. 4) to be played back without providing the frame interpolation (step S304). This stretch is not a slow stretch but a normal speed stretch, so that the data is played back at an equal speed to a normal shooting speed.

Receiving the slow stretch information (i.e. the serial numbers of a start frame and an end frame) obtained from the control information and the result of counting the number of frames, controller 180 monitors whether or not the playback process of the motion image data to be played back arrives at the slow stretch (step S305). When controller 180 determines that the playback process of the data will not arrive at the slow stretch (branch No of step S305), controller 180 keeps playback action in step S304.

When controller 180 determines that the playback of the data arrives at the slow stretch (the stretch from the fourth frame to the thirteenth frame shown in FIG. 4) (branch Yes of step S305), image processor 160 interpolates a new frame between each frame of the motion image data (60 fps) to be played back. These new frames are generated based on the frames arranged in time-series. For instance, as FIG. 4 shows, in order to interpolate one frame between the fourth frame and the fifth frame, motion image data constituting the one frame is generated based on the motion image data of the fourth and the fifth frames. The method for interpolating a frame is not limited to the foregoing one, for instance, each frame can be played back taking a longer time such as two times longer, three times longer, namely, simple multiple times longer. Here is another method; in addition to this method of playback with a longer time in simple multiple times, the forgoing method of generating a new frame based on the two frames arranged in time-series can be implemented.

In this embodiment, a newly generated one frame is interpolated between each frame constituting the motion image data to be played back, where this new frame is generated based on the two frames arranged in time-series. As a result, the motion image data to be played back in the slow stretch amounts to double in data volume. As described in item 2-1 (Motion Picture Recording Action), the data amount of the motion image data recorded in the slow stretch of the record stream is 120 frames per second, so that a data amount played back in the slow stretch through the frame interpolation process becomes twice, namely, 240 frames per second. Monitor display 220 plays back and displays this motion image data having a data amount of 240 fps at the rate of 60 frames per second. As a result, the motion picture is played back in slow motion at a rate of as slow as ¼ times speed.

As discussed in this embodiment, the frames in the slow stretch shot at 120 fps are played back at ½ times speed without the frame interpolation process. On the other hand, the frames provided with the frame interpolation process that doubles the number of frames are played back in slow motion at ¼ times speed. However, the frame interpolation process can be changed for increasing a data amount three times or four times, the playback is done in slow motion at ⅙ times or ⅛ times speed respectively.

When the step returns to step S305 and during the playback of the slow stretch, receiving the slow stretch information (i.e. the serial numbers of the start frame and the end frame) obtained from the control information and the result of counting the number of frames, controller 180 monitors whether or not the motion image data to be played back in the slow stretch is under playback action. When controller 180 determines that the motion image data of the slow stretch is still under playback action (branch Yes of step S305), controller 180 keeps the playback action in step S 306.

On the other hand, when controller 180 determines that the playback of the slow stretch is ended (branch No of step S305), controller 180 ends the process of interpolating a frame between each frame constituting the motion image data to be played back, and returns to the playback action without frame interpolation (step S304). In the case of the example shown in FIG. 4, the slow stretch ends at the thirteenth frame that is the end frame, and the motion image data is played back at the equal speed to the normal shooting speed from the fourteenth frame and onward that is a normal speed stretch.

The playback stop action is done by depressing the motion picture playback button of operational member 210. The playback-stop action is an interrupt action, and it is executed at an appropriate timing during the playback action after the depression of the motion picture playback button. Controller 180 stops playing back the motion image data on monitor display 220 upon receiving the depression of the motion picture playback button after starting the playback.

### 3. Advantages

As discussed previously, digital video camera 100 includes controller 180 that records a motion picture stream, containing a slow stretch formed of a group of frames shot at a ½ speed, into memory card 200. Controller 180 then reads out the recorded motion picture stream. In the case of playing back the read-out motion picture stream, the slow stretch in the stream is provided with the frame interpolation process by image processor 160 before this stretch is played back at a speed slower than the half speed. This mechanism allows achieving a more effective playback in slow motion.

Image processor 160 plays back the motion picture stream other than the slow stretch, formed of the group of frames shot at a ½ speed, at the equal speed to the normal shooting speed. As a result, the normal speed stretch and the slow stretch can be played back with nice variation.

Controller 180 reads out the control information from memory card 200. This control information is formed when the motion picture stream is recorded, and includes the description about the start and the end frames of the slow stretch formed of the group of frames shot at a ½ speed. Image processor 160 then determines which is the slow stretch based on the description about the start and the end frames contained in the control information. The group of frames, which was designated as the slow stretch when the motion picture has been recorded, can be thus played back in slow motion more effectively.

### 4. Other Embodiments

In the above embodiment, an example of a technique disclosed in this patent application is described; however, the technique disclosed in this application is not limited to the above embodiment and is applicable to other embodiments with a change, replacement, supplement, or omission. The structural elements described in the embodiment can be combined for establishing a new embodiment. An example of embodiments will be described below.

In the previous embodiment, NTSC signal format is taken as an example, so that an interpolation from 120 fps to 60 fps is illustrated as an example; however, the present disclosure is not limited to these examples. For instance in the case of PAL signal format, an interpolation from 100 fps to 50 fps can be used.

In the previous embodiment, when the stream is played back, controller 180 reads out the control information from memory card 200 for obtaining the information about the slow stretch, so that controller 180 can achieve the playback in slow motion. However, in order to play back the motion image data recorded in the slow stretch with this stretch being provided with the frame interpolation process, a playback apparatus needs to realize how the information about the slow stretch is embedded in the control information, and yet, the playback apparatus needs to have a function of frame interpolation. In other words, a playback apparatus that cannot obtain the information about the slow stretch and that does not have the function of frame interpolation cannot play back the motion picture in slow motion. To overcome this problem, a function called “transcode” is introduced. This transcode function allows the slow stretch to be provided with the frame interpolation process before the motion image data is recorded, whereby the foregoing playback apparatus is capable of generating motion image data to be played back in slow motion.

In the previous embodiment, the stream including both of a normal speed shooting mode and a high speed shooting mode is demonstrated, and the frames not in the slow stretch are played back without the frame interpolation; however, the present disclosure is not limited to this embodiment. The present disclosure is applicable to a motion picture playback apparatus in which two or more than two playback modes having different playback speeds from each other are available. In this case, when a playback action moves from a higher speed stretch to a lower speed stretch (i.e. slow stretch), a frame rate can be adjusted such that the slow stretch can be played back at a further low speed.

In the previous embodiment, the slow stretch information, which has been written in the control information during the recording of the motion picture, is read out in the motion picture playback mode to be used for the frame interpolation given to the motion image data to be played back and also for carrying out the playback in slow motion. However, the use of the slow stretch information is not limited to this one. For instance, the stretch written as a slow stretch into the control information is determined by a user that this stretch exhibits images of a critical moment, so that this stretch is possibly rather important for the user. Before a playback of the motion picture, slow stretch information corresponding to multiple motion image data recorded in memory card 200 can be read out, and the slow stretches indicated in the slow stretch information are solely extracted from the motion image data for playing back only these slow stretches sequentially. This mechanism allows playing back a motion picture formed of the motion image data, which is rather important for the user, sequentially coupled together, thereby giving more effect to an audience.

On top of that, the slow stretch information can be used this way: In the motion picture playback mode, image processor 160 can give a variety of motion picture effects (e.g. monochrome, one point color) during the playback while providing or not providing the frame interpolation and carrying out or not carrying out a slow-motion playback. These motion picture effects allow the motion image data, which is rather important stretch for the user, to be played back more impressively. In the case of reading out the slow stretch information corresponding to multiple motion image data and coupling them sequentially for playback, the foregoing motion picture effects can be used during the playback.

In the previous embodiment, controller 180 depresses the motion picture recoding button of operational member 210, and then depresses the local slow button. However, the present disclosure is not limited to this example. For instance, when the local slow button is depressed before the motion picture recording button is depressed, controller 180 can start recording in the frame non interpolation mode from a first frame and on ward. In this case, not to mention, the start frame indicated in the slow stretch information contained in the control information is numbered as a first frame.

In the above embodiment, examples of the technique disclosed in the present disclosure are described with accompanying drawings and detailed descriptions. The structural elements in the drawings or the detailed descriptions include not only elements essential for problems to be solved but also other elements necessary for detailing the examples but not necessary for solving the problems. Although these elements not necessary for solving the problems are described here, they should not be construed as essential elements for the problems to be solved.

The above embodiments only describe examples of the technique disclosed in the present disclosure, so that various changes, replacements, supplements, or omissions are allowed in the scope of claims described later or an equivalent scope thereto.

The motion picture playback apparatus of the present disclosure is applicable to digital video cameras, digital still cameras, portable-phones with camera function, or smart-phones with camera function.

What is claimed is:

1. A motion picture playback apparatus comprising:
a readout section for reading out a motion picture stream from a recording medium that records the motion picture stream including a motion picture stretch formed of a group of frames shot at a 1/N times speed; and
a processing section for providing the group of frames, shot at the 1/N times speed, with a frame interpolation process in a case of playing back the read-out motion picture stream, and playing back the group of frames at a speed slower than the 1/N times speed when the motion picture stretch in the motion picture stream is played back.

2. The motion picture playback apparatus of claim 1, wherein in the case of playing back the read-out motion picture stream and when the processing section plays back a motion picture stretch not formed of the group of frames shot at the 1/N times speed in the motion picture stream, the playback is done at a normal speed.

3. The motion picture playback apparatus of claim 1, wherein the read-out section reads out control information from the recording medium, the control information being generated when the motion picture stream is recorded and including description of a start frame and an end frame of the motion picture stretch formed of the group of frames shot at the 1/N times speed, and
wherein the processing section determines which stretch is the motion picture stretch based on the description included in the control information.

4. The motion picture playback apparatus of claim 1, wherein the readout section reads out a plurality of the motion picture streams from the recording medium, and the processing section connects the motion picture stretches of the plurality of the motion picture streams, each stretch formed of the group of frames shot at the 1/N times speed, together for playing back the connected motion picture streams.

5. The motion picture playback apparatus of claim 1, wherein the processing section provides a motion picture stream of the motion picture stretch formed of a group of frames shot at the 1/N times speed with a motion-picture effect during playback of the read-out motion picture stream.

6. A method for playing back a motion picture, the method being carried out by a motion picture playback apparatus including a processing section, the method comprising:
reading out a motion picture stream from a recording medium that records the motion picture stream containing a motion picture stretch formed of a group of frames shot at a 1/N times speed; and
providing the group of frames of the motion picture stretch with a frame interpolation process in a case of playing back the read-out motion picture stream and when the motion picture stretch formed of the group of frames shot at the 1/N speed in the motion picture stream is played back by the processing section, and carrying out a playback process at a speed slower than the 1/N times speed.
